(19) United States
(12) Patent Application Publication
(10) Pub. No.: US 2023/0178929 A1
(43) Pub. Date: Jun. 8, 2023

(54) SET OF ELECTROMECHANICAL CONNECTORS HAVING MALE AND FEMALE STRUCTURAL MEMBERS

(71) Applicant: Patrice DEGUIRE, Montreal (CA)

(72) Inventor: Patrice DEGUIRE, Montreal (CA)

(21) Appl. No.: 17/913,057

(22) PCT Filed: Mar. 19, 2021
(86) PCT No.: PCT/CA2021/050366

§ 371 Date: Sep. 20, 2022

Related U.S. Application Data
(60) Provisional application No. 62/992,310, filed on Mar. 20, 2020.

(51) Int. Cl. H01R 13/622; H01R 13/533; H01R 13/52; H01R 24/38; F16L 15/00

(52) U.S. Cl. CPC H01R 13/622; H01R 13/533; H01R 13/5219; H01R 24/38; F16L 15/008

(57) ABSTRACT

A set of electromechanical connectors comprises a female structural member having an open end and a male structural member having a tip configured for being received in the open end of the female structural member. A first active connector is fixedly received within one of the male and female structural members. A second active connector is fixedly received within another one of the male and female structural members. Interconnecting the male and female structural members causes the first active connector to come in operative contact with the second active connector. The first and second active connectors are isolated from an environment external to the set of electromechanical connectors when the male and female structural members are interconnected.

### CROSS-REFERENCE

The present application claims priority from U.S. Provisional patent application Ser. No. 62/992,310, filed on Mar. 20, 2020, the entirety of which is incorporated by reference herein.

### TECHNICAL FIELD

The present disclosure relates to the field of electrical connectors. More specifically, the present disclosure relates to a set of electromechanical connectors having male and female structural members.

### BACKGROUND

With the present prevalence of interconnected electrical, electronical and optical devices, wired connections are everywhere. Many connections are made in safe environments, for example in a household where cables are hidden from sight and connect a cable receiver to the back of a television set using a coaxial cable, or connect the back of a television set to the back of an audio amplifier using RCA cables.

Many other connections are made in less safe environments. In some cases, cables may be subject to being accidentally pulled, crushed and disconnected. In other cases, cable connections may be exposed to humidity, snow, ice, dust, shocks and other hazardous conditions. These problems may, for example, appear in industrial, commercial, medical, petrochemical environments. Optical cables that carrying huge data bandwidths over fiber may extend in the air between electrical utility poles and be exposed to rain, snow, wind and other adverse environmental conditions.

In some aerospace applications, some connections may not be exposed to humidity or to obvious risks of pulling. Regardless, accidental loss of connection may have severe consequences to the safety of an aircraft so cable connections must be protected.

Many conventional manners of connecting electrical cables or optical cables may fail to provide protection against accidental pulling, shocks and against adverse environmental conditions. Other conventional manners of connecting electrical cables or optical cables are expensive, require special installation tools or techniques and are difficult to dismount.

Therefore, there is a need for improvements that compensate for problems related to difficulties in providing safe electrical and optical cable connections.

### SUMMARY

According to the present disclosure, there is provided a set of electromechanical connectors, comprising:
a female structural member having an open end;
a male structural member having a tip configured for being received in the open end of the female structural member;
a first active connector fixedly received within one of the male and female structural members; and
a second active connector fixedly received within another one of the male and female structural members;
interconnecting the male and female structural members causes the first active connector to come in operative contact with the second active connector; and
the first and second active connectors are isolated from an environment external to the set of electromechanical connectors when the male and female structural members are interconnected.

In some implementations of the present technology, the first active connector is a male active connector and the second active connector is a female active connector.

In some implementations of the present technology, the set of electromechanical connectors further comprises a first mechanical fixation positioned within the female structural member and configured to sealingly maintain the one of the first and second active connectors embedded therein; and a second mechanical fixation positioned within the male structural member and configured to sealingly maintain the other one of the first and second active connectors embedded therein.

In some implementations of the present technology, each of the first and second mechanical fixations is selected from an adhesive, a gasket, a rubber plug and a polymeric insert.

In some implementations of the present technology, a void is formed between the male and female structural members when interconnected, the void being capable of being at a positive or negative pressure in relation to the environment external to the set of electromechanical connectors.

In some implementations of the present technology, the set of electromechanical connectors further comprises an o-ring insertable on a periphery of the tip of the male structural member and adapted for mating with the female structural member inside the open end.

In some implementations of the present technology, the female structural member is selected from a pipe fitting, a push fitting, a coupling, an adapter, a union fitting, a female hydraulic connector and a female pneumatic connector.

In some implementations of the present technology, the male member is selected from a pipe, a coupling, a bushing, an adapter, a union fitting, a male hydraulic connector and a male pneumatic connector.

In some implementations of the present technology, each of the male and female structural members is made of a material selected from brass, copper, stainless steel, black steel, plastic, PVC, ABS, polymer, and a combination thereof.

In some implementations of the present technology, the male structural member has a length that is at least equal to a length of the first or second active connector received therein; and the female structural member exclusive of the open end has a length that is at least equal to a length of the first or second active connector received therein.

In some implementations of the present technology, the one of the first and second active connectors embedded in the male structural member protrudes beyond the tip of the male structural member.

In some implementations of the present technology, the male and female structural members are adapted for being press-fitted against one another.

In some implementations of the present technology, the male and female structural members are adapted for being permanently connected with an adhesive.

In some implementations of the present technology, the male and female structural members are adapted for being welded together.

In some implementations of the present technology, the female structural member, the male structural member, the first active connector and the second structural connector share a common longitudinal axis.

In some implementations of the present technology, the male structural member is configured for being pivotally received in the female structural member; and the operative contact of the first and second active connectors is pivotable.

In some implementations of the present technology, the male and female structural members are adapted for being permanently connected with an adhesive.

In some implementations of the present technology, the male and female structural members are adapted for being welded together.

In some implementations of the present technology, the female structural member includes a first threaded pattern inside the open end; and the male structural member includes on its extremity a second threaded pattern configured for mating with the first threaded pattern.

In some implementations of the present technology, the first active connector is a male electrical connector; and the second active connector is a female electrical connector sized and configured for mating with the male electrical connector.

In some implementations of the present technology, the male electrical connector is a male RCA plug; and the female electrical connector is a female RCA jack sized and configured for mating with the male RCA plug.

In some implementations of the present technology, the male electrical connector is a male phone plug; and the female electrical connector is a female phone jack sized and configured for mating with the male phone plug.

In some implementations of the present technology, the male plug and the female phone jack are each selected from 2-conductor connectors, 3-conductor connectors and 4-conductor connectors.

In some implementations of the present technology, the male electrical connector is a male coaxial cable terminal; and the female electrical connector is a female coaxial cable terminal sized and configured for mating with the male coaxial cable terminal.

In some implementations of the present technology, the male electrical connector is a male AC/DC connector; and the female electrical connector is a female AC/DC connector sized and configured for mating with the male AC/DC connector.

In some implementations of the present technology, the set of electromechanical connectors further comprises a voltage converter directly connected to one of the male and female electrical connectors, the voltage converter being received within one of the male and female structural members, the voltage converter being selected from an AC/AC converter, an AC/DC converter, a DC/AC converter and a DC/DC converter.

In some implementations of the present technology, the first active connector is a male optical connector; and the second active connector is a female optical connector sized and configured for mating with the male optical connector.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a chart showing a plurality of pivotable electrical connectors;

FIG. 2 is another chart showing a plurality of pivotable electrical connectors;

FIG. 3 is an illustration of male and female optical connectors;

FIGS. 4a and 4b show how to connect male and female pivotable electrical or optical connectors;

FIG. 5 is a chart showing a variety of connectable male and female conduits;

FIG. 6a shows male and female pneumatic connectors;

FIG. 6b shows male and female hydraulic connectors;

FIG. 7a shows a removable push fitting;

FIG. 7b shows another removable push fitting connected to hydraulic conduits;

FIG. 8 is a chart showing a plurality of standard copper components;

FIG. 9 is an illustrative diagram of a set of electromechanical connectors according to an embodiment of the present disclosure;

FIGS. 10a and 10b show how to connect male and female electromechanical connectors according to another embodiment of the present disclosure;

FIGS. 11a and 11b show how to connect male and female electromechanical connectors according to a further embodiment of the present disclosure; and

FIGS. 12 to 19 illustrate prototypes of the electromechanical connectors according to various embodiments of the present disclosure.

Like numerals represent like features on the various drawings. Unless specifically mentioned, the drawings are not to scale.

### DETAILED DESCRIPTION

Various aspects of the present disclosure generally address one or more of the problems related to difficulties in providing safe electrical and optical cable connections.

Generally speaking, the present disclosure introduces a connection principle that can offer increased protection to an electrical or wired communication circuit that could otherwise be potentially exposed to a hostile environment such as, for example, pressure variations. The present technology introduces electromechanical and self-structuring elements that offer increased resistance of a circuit to oxidation, corrosive chemicals, bacteriological or parasitic contamination, certain levels of electromagnetic radiations, and temperature variations. These technical effects are obtained by providing a structural support to active connections such as electrical and communication connections.

The present disclosure introduces a set of electromechanical connectors, for example coming in pairs, that combine structural members and active connectors. In this context, an active connector may comprise, for example, an electrical connector or an optical connector. One structural member is a female structural member. The other structural member is a male structural member having a tip configured for being received in an open end of the female structural member. A first active connector, for example a male active connector is fixedly received in one of the male and female structural members. A second active connector, for example a female active connector is fixedly received in the other one of the male and female structural members. The first and second active connectors are positioned within the respective male and female structural members so that the first and second active connectors may come in operative contact when the male and female structural members are interconnected. In this context, an operative contact of the male and female electrical connectors is to be understood as an electrically conductive contact of one or more electrical terminals of the male connector with corresponding one or more electrical terminals of the female connector. An operative contact of the male and female optical connectors is to be understood as a contact that is sufficient for the exchange of optical signals between the male and female optical connectors.

Some active connectors may not be constructed as pairs of male and female connectors; they may for example come in contact by pressure applied on each other when the male and female structural members are fully engaged. Use of magnets attached to ensure operative contact between matching first and second active connectors is also contemplated.

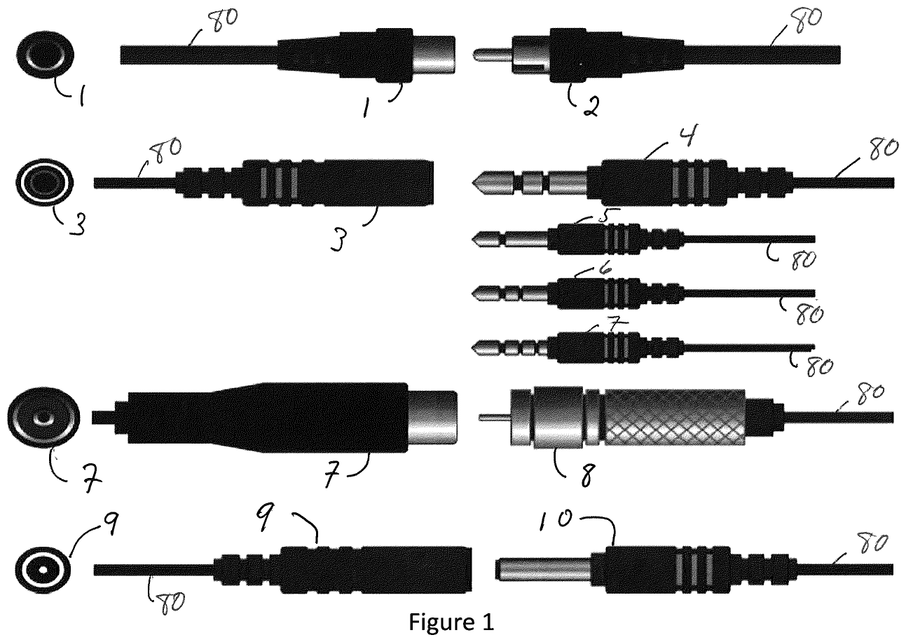

Referring now to the drawings, FIG. 1 is a chart showing a plurality of pivotable electrical connectors. A female RCA jack 1 is sized and configured to come in contact and matingly connect with a male RCA plug 2. A female phone jack 3 is sized and configured to come in contact and matingly connect with a male phone plug 4, which as illustrated is a 3-connector plug. Variants of the male phone plug 4 may include a 2-conductor plug 5, and a 4-conductor plug 6. The number of conductors of the female phone jack 3 may be selected to match the number of conductors of the male phone plug 4, 5 or 6; the conductors of the female phone jack 3 are internal and not shown on FIG. 1.

A female coaxial cable terminal 7 is sized and configured to come in contact and matingly connect with a male coaxial cable terminal 8 having an exposed ground port surrounding an internal signal port. A female AC/DC connector 9 is sized and configured to come in contact and matingly connect with a male AC/DC connector 10.

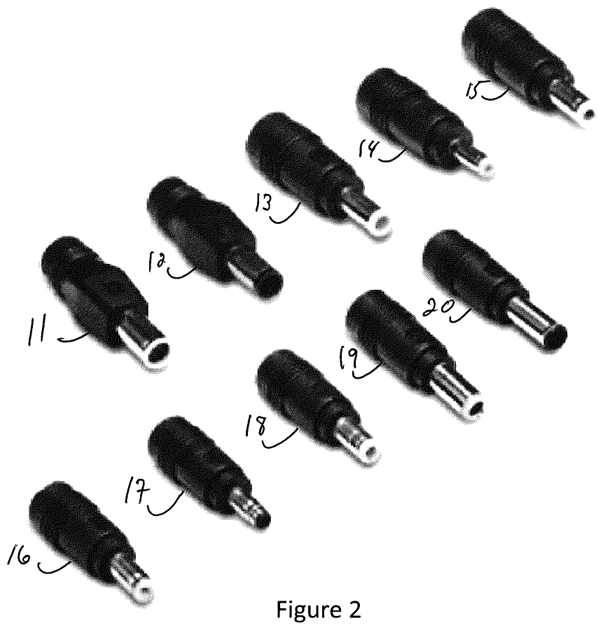

FIG. 2 is another chart showing a plurality of pivotable electrical connectors. Male AC/DC connectors 11-20 of various sizes and shapes are shown on FIG. 2. The male AC/DC connectors 11-20 are each sized and configured to come in contact and matingly connect with matching female AC/DC connectors (not shown).

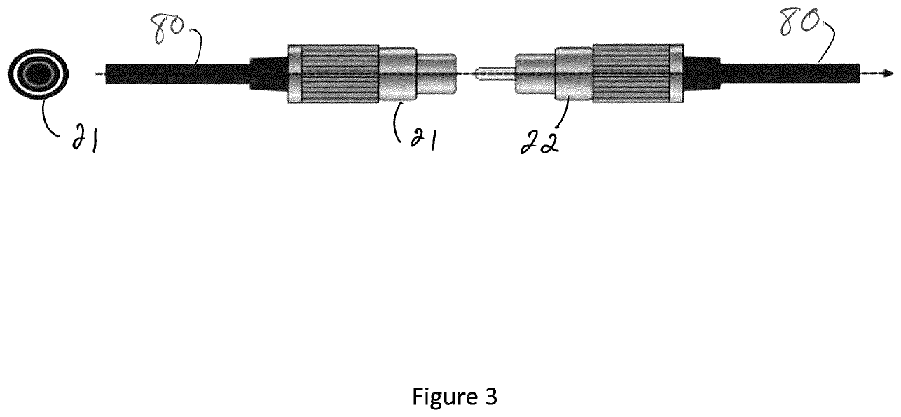

FIG. 3 is an illustration of male and female optical connectors. A female optical connector 21 is sized and configured to come in contact and matingly connect with a male optical connector 22.

Whether or not they are shown on FIGS. 1, 2 and 3 and in other drawings, each electrical or optical connector is attached to a respective wire 80. In the case of electrical connectors, the wires 80 contain a number of conductors matching a number of connections provided by the connectors. In the case of optional connectors, the wires 80 may for example contain an optical fiber.

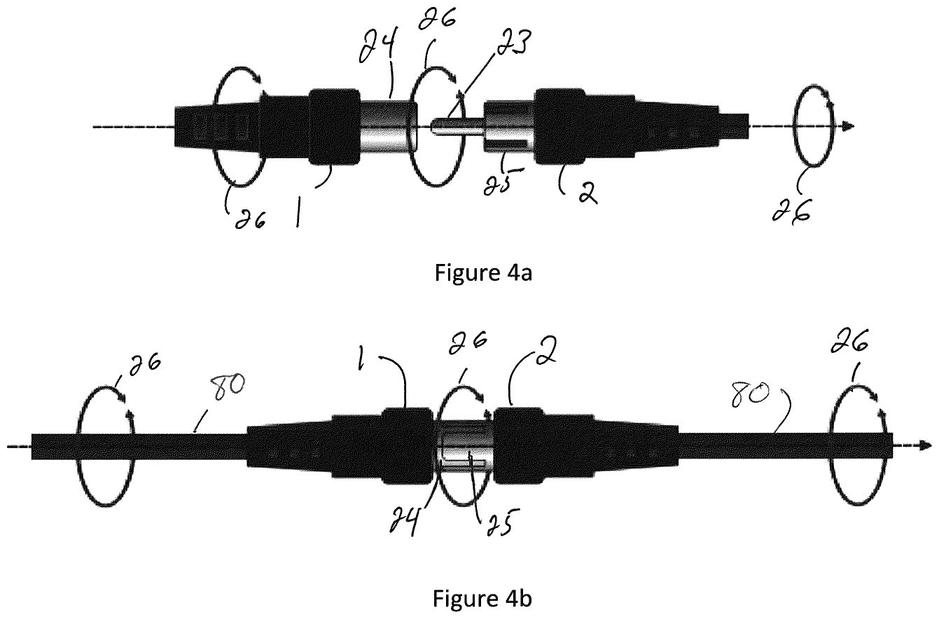

FIGS. 4a and 4b show how to connect male and female pivotable electrical or optical connectors. In the example of FIGS. 4a and 4b, the female RCA jack 1 is placed in coaxial alignment with the male RCA plug 2. Contact between the female RCA jack 1 and the male RCA plug 2 is made by inserting a tip 23 of the male RCA plug 2 within an end 24 of the female RCA jack 1 until an outer jacket 25 of the male RCA plug 2 surrounds the end 24 of the female jack 1. An electrical contact is thus made between the tip 23 of the male RCA plug 2 and an internal terminal (not shown) of the female RCA jack 1. Another electrical contact is also made between the tip 23 of the male RCA plug 2 and the end 24 of the female jack 1. Circular arrows 26 illustrate that either of the female RCA jack 1 and the male RCA plug 2 can be rotated about its longitudinal axis while making the connection, or thereafter. The manner of connecting the female RCA jack 1 and the male RCA plug 2 illustrated on FIGS. 4a and 4b is also applicable to the various electrical and optical connectors shown on FIGS. 1, 2 and 3.

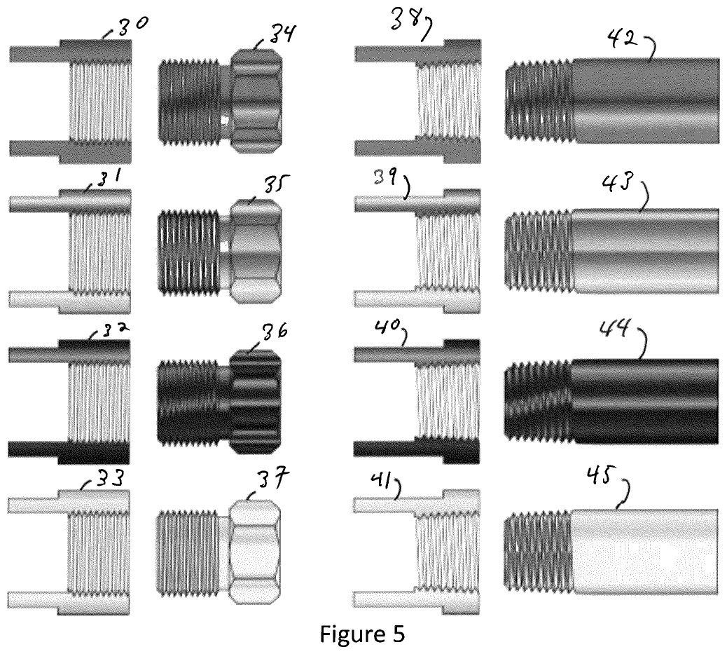

FIG. 5 is a chart showing a variety of connectable male and female conduits. Reference numbers 30-33 respectively identify female International Standardization Organization (ISO) plumbing connectors made of brass, stainless steel, black steel and polymeric materials (plastic, PVC, ABS, and the like). Reference numbers 34-37 respectively identify male ISO plumbing connectors made of the same materials as those of matching female ISO connectors 30-33. Reference numbers 38-41 respectively identify female National Pipe Thread (NPT) plumbing connectors made of brass, stainless steel, black steel and polymeric materials (plastic, PVC, ABS, and the like). Reference numbers 42-45 respectively identify male NPT pipes made of the same materials as those of matching female NPT connectors 38-41.

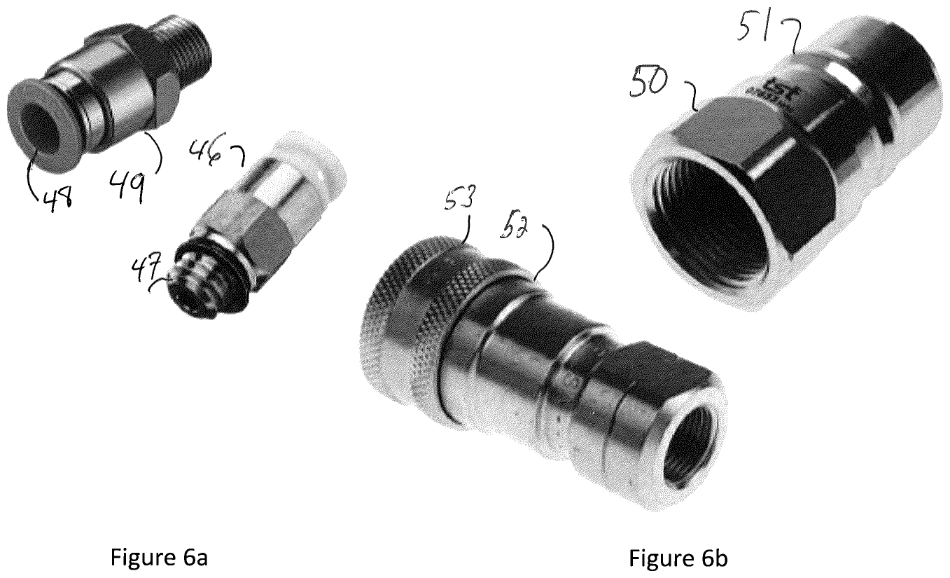

FIG. 6a shows male and female pneumatic connectors. A male pneumatic connector 46 has a tip 47 configured for insertion in an open end 48 of a female pneumatic connector 49.

FIG. 6b shows male and female hydraulic connectors. A male connector 50 has a perimetral lip 51 that, when inserted in a female connector 52 causes a small temporary displacement of a ring 53. After insertion, the ring 52 returns to its original position and effectively grasp the perimetral lip 51 to lock the male connector 50 in place.

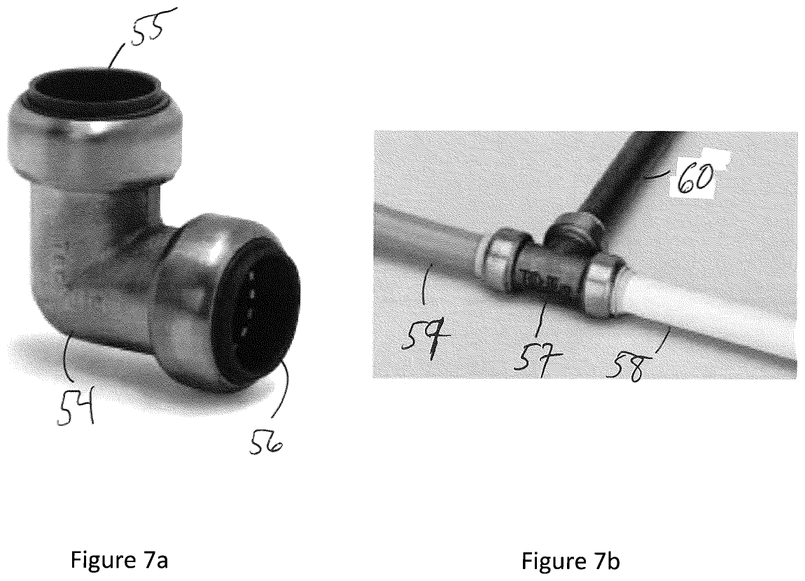

FIG. 7a shows a removable push fitting. FIG. 7b shows another removable push fitting connected to hydraulic conduits. A female connector 54 includes two openings 55 and 56. Another female connector 57 includes three openings. Each of these openings may sealingly receive a tip of a pipe, such as pipes 58, 59 and 60.

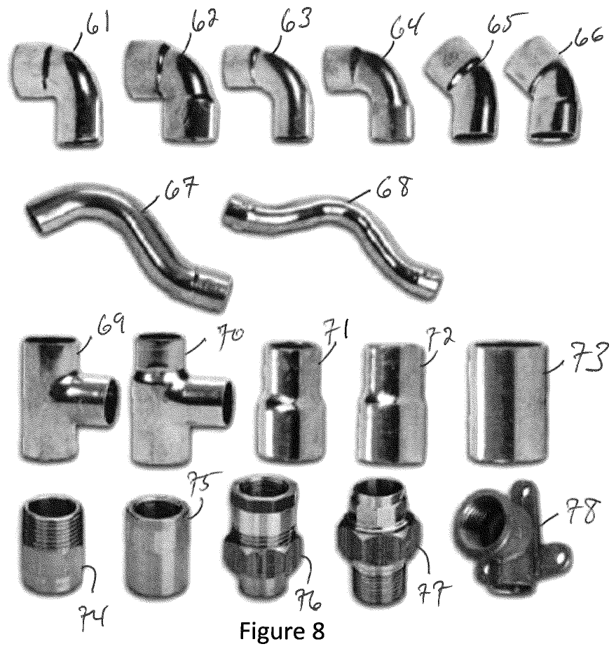

FIG. 8 is a chart showing a plurality of standard copper components. Components 61-73 do not have threaded ends while components 74-78 each comprise threads at one end. Some of these components may be used as male connectors while other components may be used as female connectors. Some components, for example components 61, 63, 65, 71 and 72 have differently sized and shaped ends and may be used as male or female connectors.

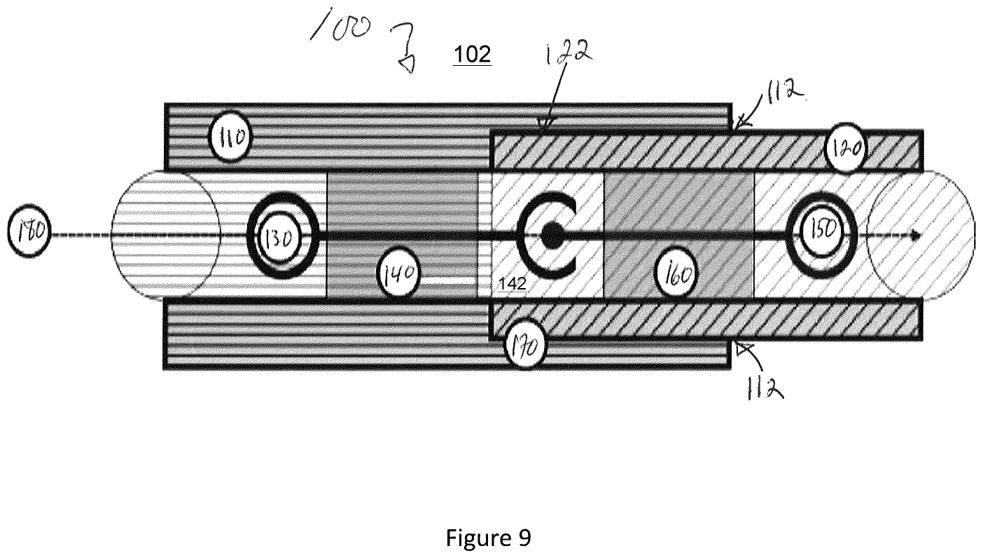

FIG. 9 is an illustrative diagram of a set of electromechanical connectors according to an embodiment of the present disclosure. A set 100 as shown includes two electromechanical connectors that are mounted together. The set 100 includes a female structural member 110 having an open end 112 and a male structural member 120 having a tip 122 received in the open end 112 of the female structural member 110. A female active connector 130, which may be a female electrical connector or a female optical connector, is fixedly received within the female structural member 110, being sealingly maintained in place by use of a mechanical fixation 140, for example an adhesive, a gasket, a rubber plug or a polymeric insert. A male active connector 150, which may be a male electrical connector or a male optical connector, is fixedly received within the male structural member 120, being sealingly maintained in place by use of a mechanical fixation 160, for example an adhesive, a gasket, a rubber plug or a polymeric insert.

Considering the example of FIG. 9, the male connector 150 and the female active connector 130 are isolated from an environment 102 external to the set 100 of electromechanical connectors when the male structural member 120 and the female structural member 130 are interconnected. The optional presence of the mechanical fixations 140 and 160 allows a void 142 positioned therebetween to be formed at a positive or negative atmospheric pressure relative the environment 102 surrounding the set 100. In addition, an o-ring (not shown) may be inserted on a periphery of the tip 122 of the male structural member 120 and adapted for mating with the female structural member 110, inside the open end 112.

A positioning depth 170 of the tip 122 of the male structural member 120 within the female structural member is selected so that interconnecting the male structural member 120 and the female structural member 110 causes the male active connector 150 to come in operative contact with the female active connector 130. Respective wires 80 (shown in other Figures) are connected to both of the female active connector 130 and the male active connector 150. Beyond ends of the female structural member 110 and of the male structural member 120 opposite from their connection point, the wires 80 may extend within appropriate conduits (not shown) or may be mounted to any structure in a conventional manner.

The various electrical connectors shown on FIGS. 1 and 2 and the optical connectors shown on FIG. 3 are all standard connectors that are readily available. The set 100 of electromechanical connectors constructed according to the present technology may use any matching pair of standard male and female active connectors. The present technology may also use non-standard active connectors, for example active connectors built specifically for use in the present electromechanical connectors as well as other custom active connectors. Likewise, the various male and female conduits and connectors illustrated on FIGS. 5 to 8 are all standard components that are readily available. The set 100 of electromechanical connectors constructed according to the present technology may use any matching pair of standard male and female conduits or connectors as male and female structural members for mounting the male and female electrical or optical connectors therein. The present technology may also use non-standard conduits and connectors, for example conduits and connectors built specifically for use in the present electromechanical connectors as well as other custom conduits and connectors.

The interconnection of the male structural member 120 with the female structural member 110, with the resulting operative contact of the male active connector 150 with the female active connector 130, may be temporary or permanent. In one aspect, a proper selection of the male structural member 120 and of the female structural member 110 may be sufficient to provide a tight and solid press-fit therebetween while optionally allowing their eventual disassembly. In another aspect, depending on the materials used, the male structural member 120 and of the female structural member 110 may be permanently connected using an adhesive or welded together. In yet another aspect, the male structural member 120 and of the female structural member 110 may have respective threaded ends allowing them to be assembled and disassembled. Thread seal tape may be used to enhance waterproofing of the resulting connection. Any one of these manners of assembling the set 100 of electromechanical connectors will provide at least a substantially waterproof fit therebetween, some of these assembly methods being entirely waterproof.

In the non-limiting example of FIG. 9, the female structural member 110, the male structural member 120, the female active connector 130 and the male active connector 140 all share a common longitudinal axis 180. In this example, the male structural member 120 may be pivotally received in the female structural member 11 and the operative contact of the female active connector 130 with the male active connector 150 is pivotable. A modification of the set 100 of electromechanical connectors in which the male active connector is AC power plug or an RJ45 plug and the female active connector an AC socket of an RJ45 socket is also contemplated. This modification provides an arrangement that does not allow pivoting the male structural member 120 in relation to the female structural member 110 following contact of the male active connector with the female active connector.

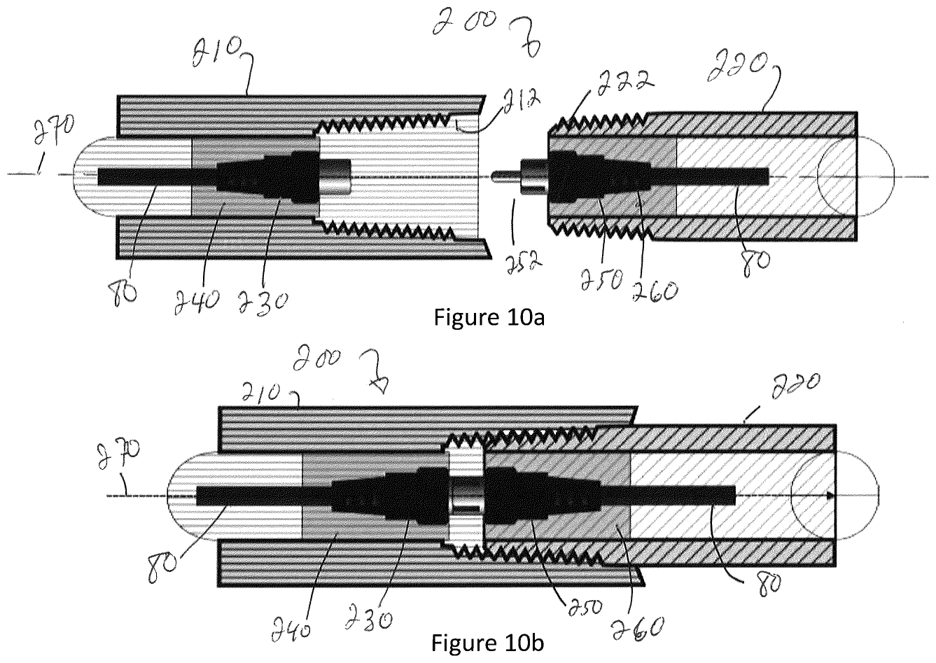

FIGS. 10a and 10b show how to connect male and female electromechanical connectors according to another embodiment of the present disclosure. In a variant, a set 200 includes a female structural member 210 having an internal threaded pattern in its end 212 and a male structural member 220 having a corresponding external threaded pattern on its tip 222; it is noted that the threads are shown with a frustoconical shape for illustration purposes only. The tip 222 of the male structural member 220 may is rotatably received in the open end 212 of the female structural member 210. A female active connector 230 is fixedly received within the female structural member 210, being sealingly maintained in place by use of a mechanical fixation 240. A male active connector 250 is fixedly received within the male structural member 220, being sealingly maintained in place by use of a mechanical fixation 260.

As illustrated, a length of the female structural member 210, exclusive of the open end 212, as measured along a common longitudinal axis 270 is at least equal to a length of the female active connector 230. Likewise, a length of the male structural member 220 as measured along a common longitudinal axis 270 is at least equal to a length of the male active connector 250. FIG. 10a also illustrates that the male active connector 250 has a tip 252 that protrudes beyond the tip of the male structural member 220.

In other aspects, the set 200 is similar to the set 100 of electromechanical connectors.

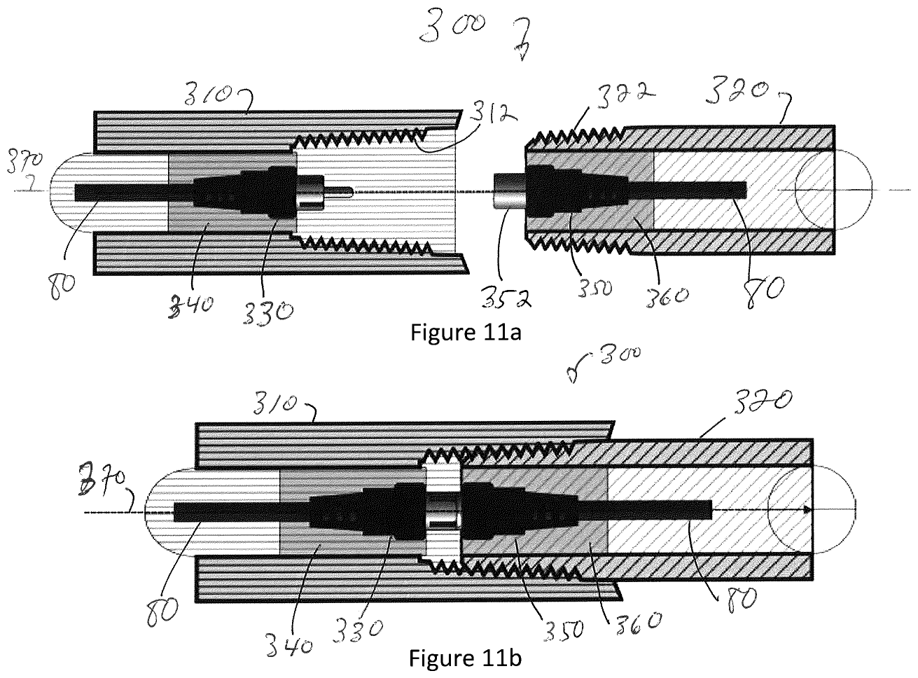

FIGS. 11a and 11b show how to connect male and female electromechanical connectors according to a further embodiment of the present disclosure. A set 300 of electromechanical connectors differs from the set 200 in that a female active connector is received in a male structural member and in that a male active connector is received in a female structural member. In more details, the set 300 includes a female structural member 310 having an internal threaded pattern in its end 312 and a male structural member 320 having a corresponding external threaded pattern on its tip 322. The tip 322 of the male structural member 320 may is rotatably received in the open end 312 of the female structural member 210. A male active connector 330 is fixedly received within the female structural member 310, being sealingly maintained in place by use of a mechanical fixation 340. A female active connector 350 is fixedly received within the male structural member 320, being sealingly maintained in place by use of a mechanical fixation 360. The female active connector 350 has a tip 252 that protrudes beyond the tip of the male structural member 320.

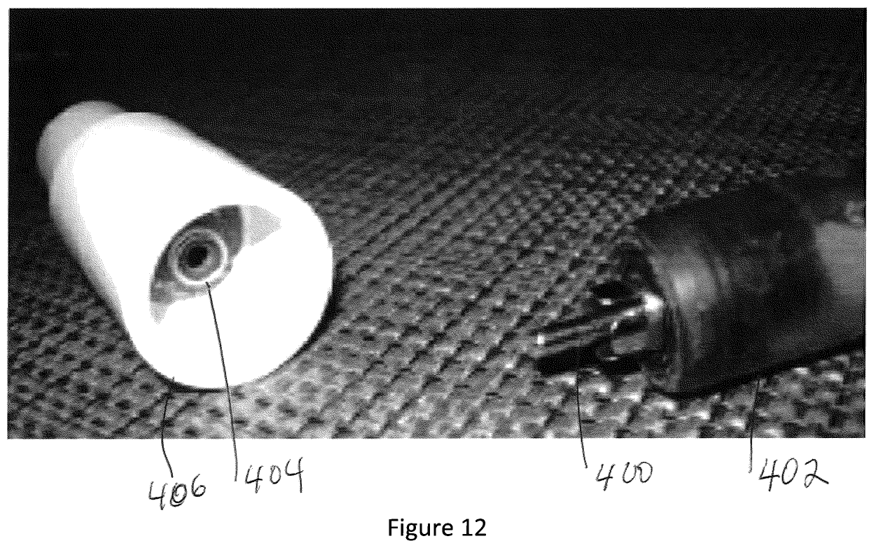

FIGS. 12 to 19 illustrate prototypes of the electromechanical connectors according to various embodiments of the present disclosure. FIG. 12 shows an RCA plug 400 mounted in a male PVC tube 402 and an RCA jack 404 mounted in a female PVC connector 406. The male PVC tube 402 and the female PVC connector 406 may optionally be glued together to form a permanent connection.

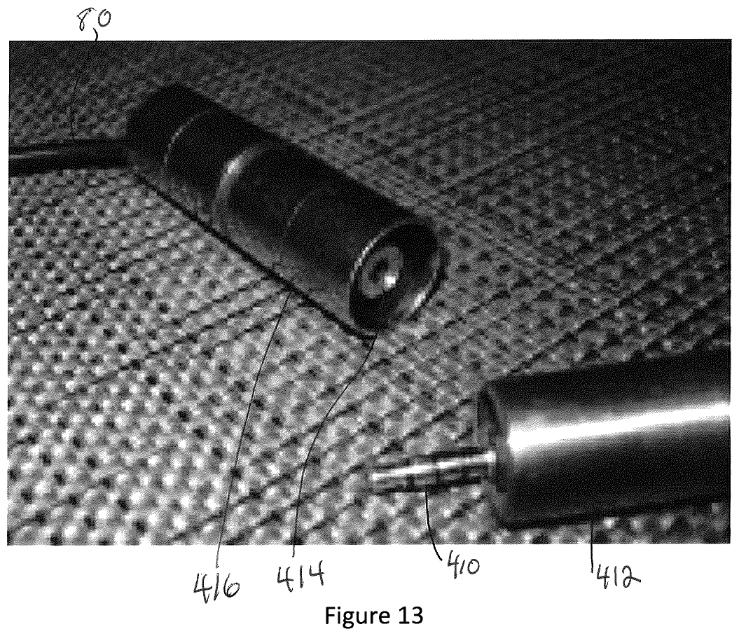

FIG. 13 shows a 4-conductor male phone plug 410 mounted in a male copper tube 412 and a female phone jack 414 mounted in a female copper tube 416. The male copper tube 412 and the female copper tube 416 may optionally be welded together to from a permanent connection.

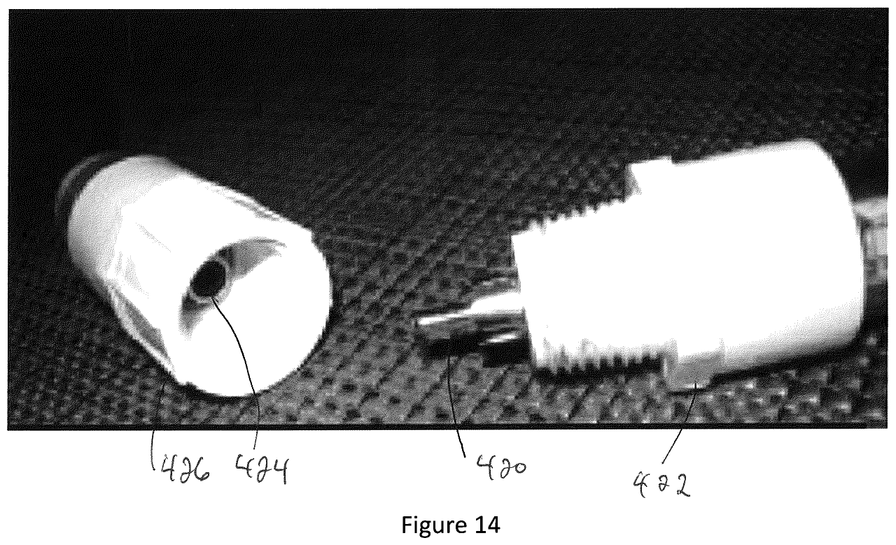

FIG. 14 shows an RCA plug 420 mounted in a male PVC NPT connector 422 and an RCA jack 424 mounted in a female PVC NPT connector 426. The male PVC NPT connector 422 and the female PVC NPT connector 426 respectively have external and internal threads allowing them to be assembled and disassembled.

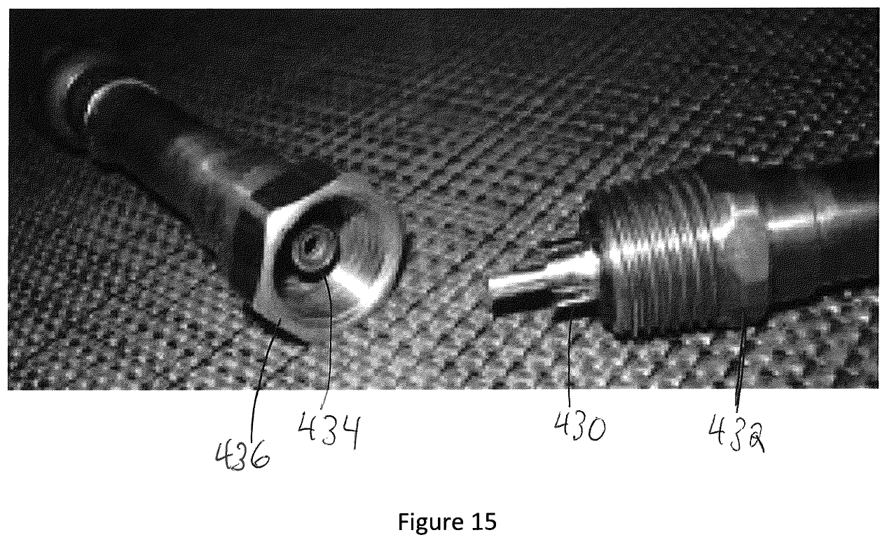

FIG. 15 shows an RCA plug 430 mounted in a male copper ISO connector 432 and an RCA jack 434 mounted in a female copper ISO connector 436. The male copper ISO connector 432 and the female copper ISO connector 436 respectively have external and internal threads allowing them to be assembled and disassembled.

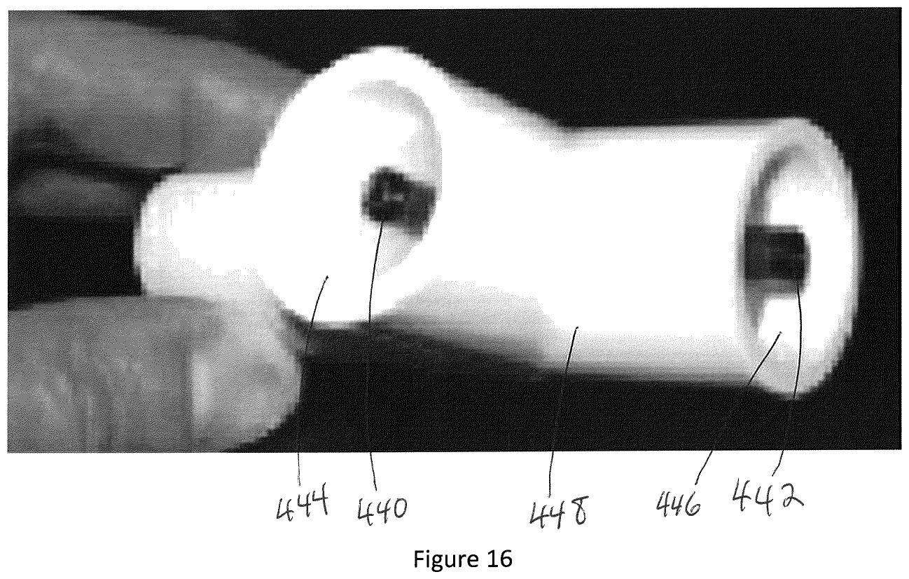

FIG. 16 shows two male AC/DC connectors 440 and 442 mounted in respective openings 444 and 446 of a T-shaped PVC connector 448. Each of the openings 444 and 446 may act as a respective female structural member for the male AC/DC connectors 440 and 442. The male AC/DC connectors 440 and 442 may either be connected to distinct wires (not shown) within the T-shaped PVC connector 448 or may optionally be electrically connected within the T-shaped PVC connector 448. One male structural member hosting a female AC/DC connector (not shown) may be attached to each of the openings 444 and 446 for connecting the female AC/DC connectors to the male AC/DC connectors 440 and 442. These male and female structural members may be glued to form permanent connections.

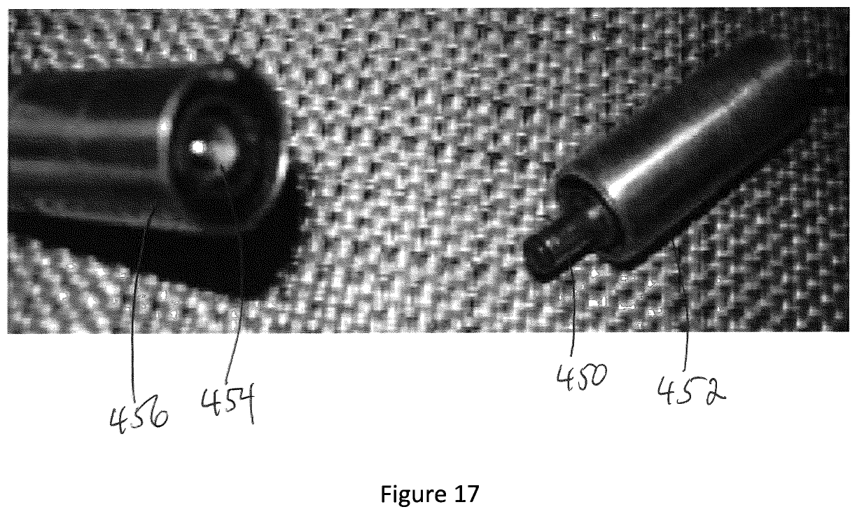

FIG. 17 shows a male AC/DC connector 450 mounted in a male copper tube 452 and a female AC/DC connector 452 mounted in a female copper tube 454. The male copper tube 412 and the male copper tube 412 may optionally be welded together to from a permanent connection.

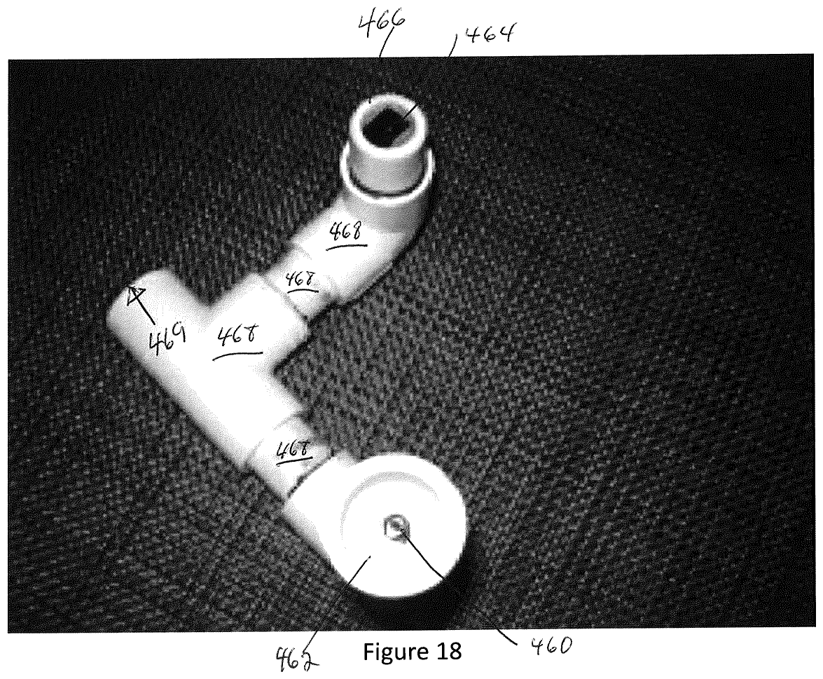

FIG. 18 shows a combination comprising a male AC/DC connector 460 mounted in a female PVC connector 462 and a female AC/DC connector 464 mounted in a male PVC tube 466. The female PVC connector 462 and the male PVC tube 466 are permanently connected via various PVC piping components 468. An internal wire (not shown) may connect the male AC/DC connector 460 to the female AC/DC connector 464. Alternatively, distinct wires (not shown) may be connected to the male AC/DC connector 460 and to the female AC/DC connector 464, the distinct wires extending beyond an opening 469 of the assembly shown on FIG. 18. The combination of the male AC/DC connector 460 with the female PVC connector 462 may be attached to a male connector hosting a female AC/DC connector (not shown). Likewise, combination of the female AC/DC connector 464 with the male PVC connector 466 may be attached to a female connector hosting a male AC/DC connector (not shown). All of these components may optionally be glued to form permanent connections.

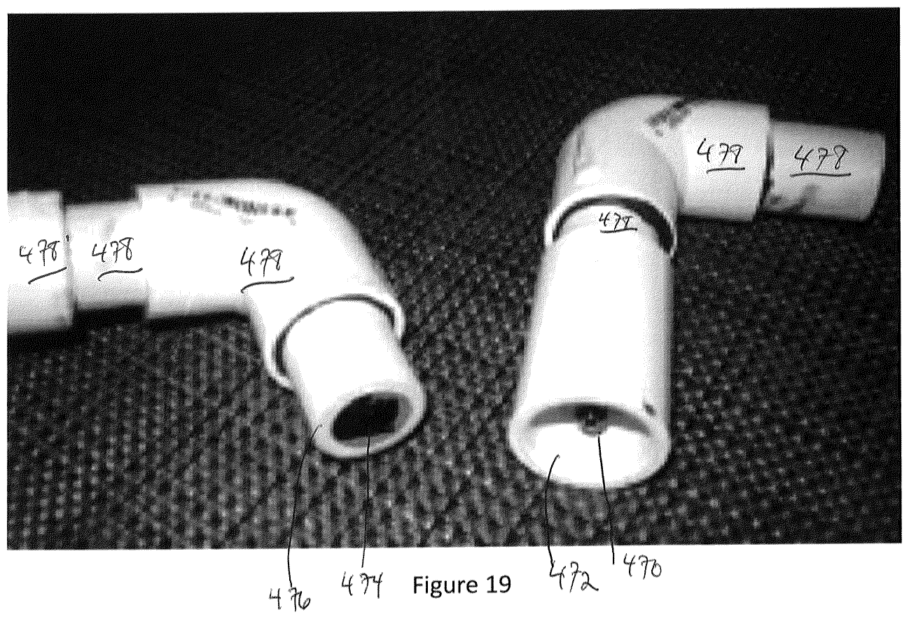

FIG. 19 shows a male AC/DC connector 470 mounted in a female PVC connector 472 and a female AC/DC connector 474 mounted in a male PVC tube 476. The female PVC connector 472 and the male PVC tube 476 are glued to various PVC piping components 478.

Although not shown on FIGS. 16-19, the set 100 of electromechanical connectors may comprise a voltage converter directly connected to one of the male and female AC/DC connectors, the voltage converter being received within one of the male and female structural members. Example of voltage converters imbedded within the sets illustrated on FIGS. 16-19 may comprise an AC/AC converter, an AC/DC converter, a DC/AC converter and a DC/DC converter.

Although not shown in the above Figures, connecting a male structural member made of one material to a female structural member made of another material is contemplated, as long as their sizes, shapes and configurations allow them to mate mechanically. As a non-limiting example, the RCA plug 420 mounted in the male PVC NPT connector 422 of FIG. 14 may be connected to the RCA jack 434 mounted in the female copper ISO connector 436 of FIG. 15, if their sizes and thread patterns are compatible. Likewise, the RCA jack 424 mounted in the female PVC NPT connector 426 of FIG. 14 may be connected to the RCA plug 430 mounted in the male copper ISO connector 432 of FIG. 15, if their sizes and thread patterns are compatible. Some materials would not allow welding or gluing of the male and female structural members. Connection of properly sized and configured threaded male and female structural members is possible in most cases.

Various embodiments of the set of electromechanical connectors, as disclosed herein, may be envisioned. Some advantages are present in all embodiments and other advantages are present in some specific embodiments.

For example, various sets of electromechanical connectors provide reliable connection to avoid any accidental disconnection as well as protection against shock from another body, crushing or other surrounding hazards present in a domestic or commercial environment. The sets of electromechanical connectors provide increased protection of a connection against the dangers of electric shock due to the connection or disconnection of an electrical circuit, whether by a child or by the inadvertence of an adult.

The sets of electromechanical connectors provide high resistance to humidity, and may serve as secure connections in an aquatic environment. The sets of electromechanical connectors resist UV rays from the sun, can safely be used in the rain or in other hostile environments such as in the presence of snow or ice. They offer equivalent protection for hot, dry or dusty environments, and increased protection during floods. The sets of electromechanical connectors are ideal for use in connections for standard household electrical appliances, and may be used in various specific conditions such as travel, leisure and outdoor. They are also useful in the car or in the travelers suitcase. They are ideal connection for small electrical devices. Various embodiments may be used in outdoor applications, in water sports, in recreational transport, and the like.

Embodiments of the sets of electromechanical connectors provide may provide increased thermal protection in humid and/or dusty environments. The same or other embodiments may emulate a Faraday cage and protect their internal components against certain electromagnetic fields. The same or other embodiments are able to withstand pressure changes in the environment, whether the environmental pressure increases or decreases after assembly of the sets of electromechanical connectors. The sets of electromechanical connectors are adaptable to high sanitary standards such as those of the food and medical industries.

The structural properties of the sets of electromechanical connectors allow them to be used for example as bulb holders in small to medium size assemblies. They are easy and safe to use and have a long useful life.

In industrial applications, the sets of electromechanical connectors provide similar reliability. Their resistance properties in hostile environments are essentially the same as those of domestic and commercial applications. The sets of electromechanical connectors may be constructed in any small or large sizes, according to the specific needs of the industry, while still providing excellent structural properties according to specific needs.

All embodiments are versatile, durable, economical, easy and quick to use, efficient, and safe. The sets of electromechanical connectors are simple, inexpensive, durable, and easy to manufacture, assemble, and disassemble. It is also easy, quick and inexpensive to modify existing electrical, electronical or optical circuits. With few exceptions, persons skilled in the art of electrical, electronical and optical circuits may employ the present technology without further training. Embodiments are ergonomical and versatile, some embodiments being adapted for universal use. Most embodiments require no or minimal specific maintenance after installation.

Most embodiments of the sets of electromechanical connectors are environmentally friendly and, with some exceptions, may be made from recycled materials. Most embodiments may be recycled at the end of its useful life.

Embodiments of the sets of electromechanical connectors may be developed and/or adapted to support any existing type of wired connections. The present technology may adapt and integrate easily into virtually all existing electrical system. The structural members of the sets of electromechanical connectors offer countless possibilities for mounting in new or already existing electrical, electronical and optical circuits.

Some embodiments of the sets of electromechanical connectors significantly extend the useful life of a circuit exposed to a hostile environment. Such embodiments are able to maintain excellent sealing and structuring force ratio, even in cases where different materials are used in male and female combinations of connectors corresponding to common interlocking standards.

The present technology is adaptable to all standard or non-standard pipe diameters, whether rigid or flexible, and to any standard or non-standard wiring methods and connection methods. Amperage tolerance and voltage tolerance of the present technology is only limited by the type of electrical connectors uses in constructing the sets of electromechanical connectors. The present technology may eventually be adapted to international connectivity standards.

The present technology introduces sets of electromechanical connectors that may increases security against tempering by young children. Such connectors can further secure electrical connections in hazardous areas such as in bathrooms, showers, kitchen, gardens, roofs, wet basement, and flooded areas. Risks of accidental disconnection are greatly diminished.

The present technology is efficient in protecting electrical circuits from innocent handling by children unaware of potential risks of electrocution. It also protects electrical circuits from inadvertent or intentional misuse by machine operators.

The present technology may be applied in many industrial, architectural, commercial and domestic uses. Non-limiting examples include aerospace industries, nuclear industries, and telecommunications industries. A particular example in the agricultural industry includes greenhouse electrical networks, in which the present technology may facilitate the development of hydroponics or vertical crops. Other examples include livestock industries, including without limitation dairy, pig, beef, sheep, and poultry farms.

Other examples of industrial applications include shows and Performing Arts, food, medical, pharmaceutical, transformation, exploration, exploitation, electronics, robotics, fisheries, forestry, processing in forestry, mining or other industrial sectors at primary, secondary and tertiary levels.

Further application examples include the transport industry, whether by car, train, truck, boat or aircraft.

Non-commercial applications may include, for example and without limitation, electrical connections used in vivariums, aquariums, gardens, water gardens, swimming pools, SPAs, and water activities.

Further commercial or domestic applications that may be greatly simplified using the present technology include setting up of small electrical networks including solar (photovoltaic) panels, small wind turbines, outdoor lighting such as in gardens.

Those of ordinary skill in the art will realize that the description of the set of electromechanical connectors is illustrative only and is not intended to be in any way limiting. Other embodiments will readily suggest themselves to such persons with ordinary skill in the art having the benefit of the present disclosure. Furthermore, the disclosed set of electromechanical connectors may be customized to offer valuable solutions to existing needs and problems related to difficulties in providing safe electrical and optical cable connections. In the interest of clarity, not all of the routine features of the implementations of the set of electromechanical connectors are shown and described. In particular, combinations of features are not limited to those presented in the foregoing description as combinations of elements listed in the appended claims form an integral part of the present disclosure. It will, of course, be appreciated that in the development of any such actual implementation of the set of electromechanical connectors, numerous implementation-specific decisions may need to be made in order to achieve the developer's specific goals, such as compliance with application-related, system-related, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of electrical connectors having the benefit of the present disclosure.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

1. A set of electromechanical connectors, comprising:
a female structural member having an open end;
a male structural member having a tip configured for being received in the open end of the female structural member;
a first active connector fixedly received within one of the male and female structural members;
a second active connector fixedly received within another one of the male and female structural members;
a first mechanical fixation positioned within the female structural member and configured to sealingly maintain the one of the first and second active connectors embedded therein;
a second mechanical fixation positioned within the male structural member and configured to sealingly maintain the other one of the first and second active connectors embedded therein; and
an o-ring insertable on a periphery of the tip of the male structural member and adapted for mating with the female structural member inside the open end;
wherein interconnecting the male and female structural members causes the first active connector to come in operative contact with the second active connector; and
wherein the first and second active connectors are isolated from an environment external to the set of electromechanical connectors when the male and female structural members are interconnected.

2. The set of electromechanical connectors of claim 1, wherein the first active connector is a male active connector and the second active connector is a female active connector.

3. (canceled)

4. The set of electromechanical connectors of claim 1, wherein each of the first and second mechanical fixations is selected from an adhesive, a gasket, a rubber plug and a polymeric insert.

5. The set of electromechanical connectors of claim 1, wherein a void is formed between the male and female structural members when interconnected, the void being capable of being at a positive or negative pressure in relation to the environment external to the set of electromechanical connectors.

6. (canceled)

7. The set of electromechanical connectors of claim 1, wherein the female structural member is selected from a pipe fitting, a push fitting, a coupling, an adapter, a union fitting, a female hydraulic connector and a female pneumatic connector.

8. The set of electromechanical connectors of claim 1, wherein the male structural member is selected from a pipe, a coupling, a bushing, an adapter, a union fitting, a male hydraulic connector and a male pneumatic connector.

9. The set of electromechanical connectors of claim 1, wherein each of the male and female structural members is made of a material selected from brass, copper, stainless steel, black steel, plastic, PVC, ABS, polymer, and a combination thereof.

10. The set of electromechanical connectors of claim 1, wherein:
the male structural member has a length that is at least equal to a length of the first or second active connector received therein; and
the female structural member exclusive of the open end has a length that is at least equal to a length of the first or second active connector received therein.

11. The set of electromechanical connectors of claim 1, wherein the one of the first and second active connectors embedded in the male structural member protrudes beyond the tip of the male structural member.

12. The set of electromechanical connectors of claim 1, wherein the male and female structural members are adapted for being press-fitted against one another.

13. The set of electromechanical connectors of claim 1, wherein the male and female structural members are adapted for being permanently connected with an adhesive.

14. The set of electromechanical connectors of claim 1, wherein the male and female structural members are adapted for being welded together.

15. A set of electromechanical connectors, comprising:
a female structural member having an open end;
a male structural member having a tip configured for being received in the open end of the female structural member;
a first active connector fixedly received within one of the male and female structural members; and
a second active connector fixedly received within another one of the male and female structural members;
wherein:
interconnecting the male and female structural members causes the first active connector to come in operative contact with the second active connector;
the first and second active connectors are isolated from an environment external to the set of electromechanical connectors when the male and female structural members are interconnected;
the female structural member, the male structural member, the first active connector and the second structural connector share a common longitudinal axis;
the male structural member is configured for being pivotally received in the female structural member;
the operative contact of the first and second active connectors is pivotable;
the female structural member includes a first threaded pattern inside the open end; and
the male structural member includes on its extremity a second threaded pattern configured for mating with the first threaded pattern.

16-19. (canceled)

20. The set of electromechanical connectors of claim 15, wherein:
the first active connector is a male electrical connector; and
the second active connector is a female electrical connector sized and configured for mating with the male electrical connector.

21. The set of electromechanical connectors of claim 20, wherein:
the male electrical connector is a male RCA plug; and
the female electrical connector is a female RCA jack sized and configured for mating with the male RCA plug.

22. The set of electromechanical connectors of claim 20, wherein:
the male electrical connector is a male phone plug; and
the female electrical connector is a female phone jack sized and configured for mating with the male phone plug.

23. (canceled)

24. The set of electromechanical connectors of claim 20, wherein:
the male electrical connector is a male coaxial cable terminal; and
the female electrical connector is a female coaxial cable terminal sized and configured for mating with the male coaxial cable terminal.

25. The set of electromechanical connectors of claim 20, wherein:
the male electrical connector is a male AC/DC connector; and
the female electrical connector is a female AC/DC connector sized and configured for mating with the male AC/DC connector.

26. The set of electromechanical connectors of claim 20, further comprising a voltage converter directly connected to one of the male and female electrical connectors, the voltage converter being received within one of the male and female structural members, the voltage converter being selected from an AC/AC converter, an AC/DC converter, a DC/AC converter and a DC/DC converter.

27. The A set of electromechanical connectors, comprising:
a female structural member having an open end;
a male structural member having a tip configured for being received in the open end of the female structural member;
a first active connector fixedly received within one of the male and female structural members; and
a second active connector fixedly received within another one of the male and female structural members;
wherein:
interconnecting the male and female structural members causes the first active connector to come in operative contact with the second active connector;
the first and second active connectors are isolated from an environment external to the set of electromechanical connectors when the male and female structural members are interconnected;
the female structural member, the male structural member, the first active connector and the second structural connector share a common longitudinal axis;
the male structural member is configured for being pivotally received in the female structural member;
the operative contact of the first and second active connectors is pivotable;
the first active connector is a male optical connector; and
the second active connector is a female optical connector sized and configured for mating with the male optical connector.
